(19) United States
(12) Patent Application Publication
(10) Pub. No.: US 2005/0083885 A1
(43) Pub. Date: Apr. 21, 2005

(54) Movement detection method and a mobile terminal

(76) Inventors: Shinkichi Ikeda, Yokohama-shi (JP); Makoto Funabiki, Tokyo (JP)

Correspondence Address: RATNERPRESTIA, P O BOX 980, VALLEY FORGE, PA, 19482-0980, US

(21) Appl. No.: 10/963,920

(22) Filed: Oct. 13, 2004

(30) Foreign Application Priority Data
Oct. 17, 2003 (JP) 2003-357725
Sep. 13, 2004 (JP) 2004-265140

(51) Int. Cl. H04Q 7/00; H04J 3/16

(52) U.S. Cl. 370/331; 370/469

(57) ABSTRACT

In accordance with a movement detection method, a mobile terminal in moving among access router devices all set at the same frequency, stores the link layer address of the currently reachable access router device. When receiving a Layer 2 frame from a new access router device, the mobile terminal issues a trigger for requesting to implement a part of IP handover processing. By so doing, it allows IP handover processing to be initiated at higher speed than in the case of the conventional IP layer, thus enabling to reduce the total time of handover processing.

### FIELD OF THE INVENTION

The present invention relates to a method of movement detection of a mobile terminal implementing an internet protocol and further an IP mobility procedure like as Mobile IP.

### BACKGROUND OF THE INVENTION

There is a Mobile IP as one of movement controlling methods in the internet system, where Mobile IPv4 corresponding to IPv4 is standardized by RFC3220 (IP Mobility Support). Besides, Mobile IPv6 corresponding to IPv6 is in process of standardization by the Internet-Draft “draft-ietf-mobileip-ipv6 (Mobility Support in IPv6)” even now. Thanks to these protocols, it is made possible to continue the communication with the use of the same address if a mobile terminal moves between different networks. In Mobile IP, the mobile terminal will, when it is away from the home link, form a care-of address to be temporarily used on the link by obtaining prefix information of the currently connected link from the network information that is transmitted from the access router device on the link of the current connection. After that, by sending a Binding Update message to the home agent, the care-of address is registered in the home agent on the mobile terminal's home link as a primary care-of address. After the reception of the Binding Update message from the mobile terminal, the home agent updates a Binding Cache that associates the home address of the mobile terminal with its care-of address.

The home agent, by referring to the Binding Cache, intercepts and encapsulates packets addressed to the home address of the mobile terminal for forwarding it to the mobile terminal's care-of address. The mobile terminal can receive the packet addressed to the mobile terminal's home address by performing a de-capsulation of the packet forwarded by the home agent.

Conventionally, there is disclosed a method applied to the movement detection for a mobile terminal in this field in Japanese Non-examined Patent Publication 2002-191066.

FIG. 10 is a sequence diagram showing the registration processing in the case of movement from one foreign network to another foreign network in the conventional radio mobile communication system.

In FIG. 10, a mobile terminal MN301 performs a movement detection with the use of an Agent Advertisement messages 401 periodically transmitted by a foreign agent specified by Mobile IPv4. That means, when it is confirmed that an Advertisement message 403 has been received from a foreign agent FAnew306 that is to be connected in the movement destination network which the mobile terminal MN301 moved to, and is different from a foreign agent FAcur303 connected in the prior-to-movement network which the mobile terminal MN301 moved from, the mobile terminal deems that the movement is detected and implements a registration procedure to a home agent HA 309 according to the Mobile IP procedures (404 to 407). Incidentally, the Agent Advertisement message is an expanded message of a Router Advertisement message to be hereinafter described. That means, for more general-purpose, network movement can be detected by referring to the IP address of a router transmitting the Router Advertisement message and a network prefix information included in the Router Advertisement message. This can be practicable not only in Mobile IPv4 but also in Mobile IPv6 and further in a system not applied to the Mobile IP.

Herein, there is demonstrated the IP handover processing to be implemented when the mobile terminal moves between networks with the use of FIG. 11.

In FIG. 11, the mobile terminal 20 performs data transmission/reception via currently connected prior-to-movement access router 100c. The mobile terminal 20 periodically searches channels to access with best condition (S1501). As a result, if an access router device 100d having higher connectivility than the currently connected access router 100c is detected, it is determined as a movement destination access router for the mobile terminal 20 to handover, and Layer2 (L2) connection processing including association and so on is to be implemented (S1502). In IEEE 802.11, this corresponds to the processing that includes association.

Next, in order to establish a Layer3 (L3) connection, the mobile terminal 20 transmits more than one Router Solicitation (RtSol) message (S1503) and waits for receiving a Router Advertisement (RtAdv) message from the movement destination access router device 10d. The movement destination access router device 100d sets a maximum of 500 ms of random waiting time interval from the reception of the Router Solicitation message (S1503) to the transmission of the Router Advertisement message (S1504). This is a protocol rule for avoiding the data interference caused by Router Advertisement messages from plural router devices.

Next, the mobile terminal 20, when receiving the Router Advertisement message (S1504), is to detect if the network is different from the one previously connected by referring to network prefixes described in the message and so on. If it deems that the network is a different one, then it determines to initiate IP handover and forms an IP address. If there is no address collision existing when Duplicate Address Detection is performed about the formed IP address (S1505), a Layer 3 connection (L3) is established.

Next, the mobile terminal 20 forms and transmits a Binding Update (BU) message to a home agent device 40 (S1506) and receive a Binding Acknowledgement (BA) message in reply (S1507) to complete the IP handover.

Meanwhile, as a fast handover method that applies Mobile IP, there is provided one described in “Fast Handovers for Mobile IPv6” IETF Mobile IP WG Internet-Draft. This method is to forward a packet between a prior-to-movement access router device and a movement destination access router device, and to temporarily store a packet addressed to the mobile terminal and forwarded from the prior-to-movement access router into a buffer of the movement destination access router (hereinafter referred to as “Fast Mobile IP”).

There are two methods in the Fast Mobile IP. The first implementation method is to control access router information on the network side to determine a movement destination access router. FIG. 12 is a sequence diagram showing the first embodiment of a mobile terminal's handover processing.

In FIG. 12, a mobile terminal 20 is to initiate Fast Mobile IP processing when detecting a new access router or a base station by the lower layer (L2), or when the communication condition with the access router or base station has a tendency to deteriorate. At this time, the prior-to-movement access router or the neighbor router information database retains information on the neighbor access routers, wherein the prior-to-movement access router 100c determines a movement destination access router 100d from that information. The prior-to-movement access router 100c sends a Tunnel Establishment Solicitation message (S2001), which is also called Handover Initiate message in “Fast Handovers for Mobile IPv6”, in order to establish a tunnel with the movement destination access router 10d. In reply, the movement destination access router 100d sends a Tunnel Establishment Response message (S2002), which is called Handover Acknowledge message in “Fast Handovers for Mobile IPv6”, to the prior-to-movement access router 100c.

As described above, the tunnel is established between the movement destination access router 100d and the prior-to-movement access router 100c, then a packet addressed to the mobile terminal but reached to the prior-to-movement access router 100c is forwarded to the movement destination access router 100d to be stored in the buffer thereof. After that, when the mobile terminal 20 completes a handover in the lower layer (L2), the movement destination access router 100d receives a Router Solicitation message (S2003) transmitted from the mobile terminal 20.

Next, the movement destination access router 10d, after receiving this Router Solicitation message, forwards the buffered packet addressed to the mobile terminal toward the mobile terminal 20. Also, the mobile terminal 20 performs a standard Mobile IP processing such as obtaining a new subnet prefix from the Router Advertisement message (step S2004) transmitted from the movement destination access router 100d, forming a new care-of address and updating a Binding Cache of a home agent device 40 and a communication correspondent terminal 80 (step S2005, step S2006 and step S2007). By doing so, subsequent packets from the communication correspondent terminal 80 to the mobile terminal 20 are to be directly transmitted to the movement destination access router 100d (step S2008).

The second implementation method of Fast Mobile IP is that the mobile terminal obtains information of movement destination access router to notify it to the prior-to-movement access router. Incidentally, in order to obtain information of the movement destination access router, it is necessary for the mobile terminal to have two radio interfaces, using one for connecting with the prior-to-movement access router while using the other for detecting a movement destination access router to get information. FIG. 13 is a sequence diagram showing the second method of the mobile terminal handover processing.

In FIG. 13, a mobile terminal 20 is connected with a prior-to-movement access router 100c via a radio interface I/F2. At the same time, the mobile terminal 20 periodically searches channels for establishing Layer 2 connection with the use of the other radio interface I/F1. Herein, when the mobile terminal 20 receives a beacon signal S2011 from a movement destination access router 100d and determines it as a movement destination access router, it performs Layer 2 connection processing (S2012) to establish the Layer 2 connection.

Subsequently, the mobile terminal 20 sends a Router Solicitation (RtSol) message (S2013) in order to establish a Layer 3 connection, and receives a Router Advertisement (RtAdv) message from the movement destination access router 100d in reply to that (S2014). Herein, after the reception of the Router Solicitation message, the movement destination access router 100d sends the Router Advertisement message after a random waiting time-interval of the maximum 500 ms.

Next, after the reception of the Router Advertisement message, the mobile terminal 20 determines if IP handover is necessary on the basis of a network prefix described in the Router Advertisement message and so on. And if the mobile terminal 20 determines to implement IP handover, it forms an IP address with the network prefix obtained from the Router Advertisement message and performs Duplicate Address Detection(DAD) processing (S2015) specified in RFC2462.

Next, when it is confirmed that there is no address collision, it can be said that a Layer 3 connection in the mobile terminal 20 has been established. Then information of the movement destination access router 100d already obtained from the Router Advertisement message is to be described in the Fast Binding Update (FBU) message specified by the Fast Mobile IP procedure, notifying it to the prior-to-movement access router 100c via the radio interface I/F1 (S2016). The prior-to-movement access router 100c establishes a tunnel for forwarding packets addressed to the mobile terminal 20 with the movement destination access router 100d (S2017, S2018) so that the subsequent packets addressed to the mobile terminal 20 but received by the prior-to-movement access router 100c can be forwarded to the movement destination access router 100d via the established tunnel (S2019). The forwarded packet is further forwarded to the radio interface I/F2 of the mobile terminal 20 from the movement destination access router 100d via the already established L3 connection (S2020). After the transmission of Fast Binding Update message, the mobile terminal 20 performs a binding processing with a home agent device 40 (S2021, S2022), further performing a binding processing between a communication correspondent terminal 80 (S2023). Hereinafter packet communication between the mobile terminal 20 and the communication correspondent terminal 80 is to be preformed via the movement destination access router 10d.

However, in the conventional movement detection method as disclosed in Japanese Non-examined Patent Publication 2002-191066, the lower layer (Layer 2) connection processing has to be completed before receiving an Agent Advertisement message from foreign agents. Besides, in the interval from establishing the Layer 2 connection (L2 establishment) to establishing the Layer 3 connection (L3 establishment), there is to be performed such processing as determining the waiting time-interval for receiving the Router Advertisement message, the initiation of IP handover and forming an IP address, thus consuming the processing time including the protocol waiting time. Herein, the Router Advertisement message transmitted in response to inquiries by the mobile terminal is specified to set a random delay within the range from zero to 500 ms when the router sends it, taking into account the link's congestion. As a result there is a possibility to produce a movement detection delay of 500 ms at most and of a few hundred ms on average. That is to say, because there is an occurrence of at least the above-described waiting time after the Layer 2 connection until the formation of an IP address, handover time is made longer while it is difficult to estimate the time necessary for performing the handover. This will lead to the loss of application resource. For example, in the case of determining the buffer size of application data in accordance with the handover time, it is required to ensure the size enabling to accommodate the maximum amount of packets received within 500 ms but there is rare chance to actually consume all the buffer size, which is a loss of the data buffer resources.

Meanwhile, in the second implementation method of Fast Mobile IP that is described in “Fast Handover for Mobile IPv6” IETF Mobile IP WG Internet-Draft, there is a necessity to prepare two radio interfaces that leads to a problem of increasing circuits and consumption power. Further, as in the case with Japanese Non-examined Patent Publication 2002-191066, because L3 connection is established by the mobile terminal 20 by obtaining the Router Advertisement message (S2014) after the establishment of L2 connection, there occurs a waiting time before the reception of the Router Advertisement message so that it is highly possible that the connection with the prior-to-movement access router 100c is cut off before establishing the L3 connection. In such a case, it is made impossible to notify the information of the movement destination access router to the prior-to-movement access router (S2016), unable to establish a tunnel between the access router 100c and the access router 100d, thus generating a packet loss. Such kind of problem has been predictable also under the environment where a neighboring access router provides a radio access at the same frequency exemplified by a hot spot, in-house network and so on.

### SUMMARY OF THE INVENTION

The present invention is to solve the conventional problem as described above, having an object to provide a movement detection method and a mobile terminal for performing handover with less packet loss by reducing the time for handover processing when radio access service is provided at the same frequency by neighbor access routers.

In accordance with a movement detection method of the present invention for solving the above-described conventional problem, there is provided a movement detection method in a mobile terminal that implements Mobile IP procedure, wherein a mobile terminal includes a memory list storing OSI Layer 2 addresses of a currently reachable access router and notifies to an OSI Layer 3 when receiving an OSI Layer 2 frame from an access router of which address is not described on the list, characterized in that the OSI Layer 3 initiates the processing including formation of an IP address ahead of the IP handover processing.

By virtue of the features as described, the confirmation of connectivility with a new access router leads a part of IP handover processing to be previously implemented, thus realizing handover processing to be performed faster than before.

In addition, in accordance with an aspect of the present invention, the movement detection method includes the steps of: the mobile terminal that implements Mobile IP procedure obtaining an OSI Layer 2 address of a reachable router to store the obtained address in the L2 address list; an address determination step to determine if the OSI Layer 2 address of the source router sending the OSI Layer 2 frame is stored in the L2 address list when the OSI Layer 2 frame is received by the mobile terminal; and initiating a preprocessing of handover in the OSI Layer 3 when the mobile terminal determines the address not to be stored through the address determination step.

By virtue of the features as described, it is made possible to initiate a preprocessing of Layer 3 handover by issuing a movement detection trigger before the establishment of OSI Layer 2 connection with a new router. As a result, it is made possible to implement handover processing in Layer 3 immediately after the establishment of OSI Layer 2 connection.

In addition, in accordance with a movement detection method of the present invention, handover preprocessing represents a formation of a new OSI Layer 3 address based on the OSI Layer 2 frame newly received by the mobile terminal and a creation of a Binding Update message addressed to the home agent of the mobile terminal.

By virtue of the features as described, it is made possible to transmit the Binding Update message to the home agent immediately after the establishment of OSI Layer 2 connection.

In addition, in accordance with a movement detection method of the present invention, there is further provided a type determination step where the mobile terminal determines whether an OSI layer 3 packet included in the OSI Layer 2 frame is a Router Advertisement message or not before the initiation of the handover preprocessing, characterized in that the preprocessing is to be initiated in the case where it is determined to be the Router Advertisement message through this type determination step.

By virtue of the features as described, a movement detection trigger is issued only when a Router Advertisement message is received from a router in which new connectivility is confirmed. As a result, in sequential IP handover processing, it can omit the process of obtaining a new Router Advertisement message by making use of this received Router Advertisement message, thus enabling the time of handover to be reduced.

In addition, in accordance with a movement detection method of the present invention, there is provided a radio communication between the mobile terminal and the router, wherein the radio communication with the mobile terminal is to be performed at the same frequency both by a router connected prior to the movement of the mobile terminal and by a router connected after the movement.

By virtue of the features as described, even in a radio communication usage state provided between the mobile terminal and the router, the time of handover can be reduced according to the present invention in the case where communication with the mobile terminal can be performed at the same frequency both by a router connected prior to the movement of the mobile terminal and by a router connected after the movement.

In accordance with a movement detection method of the present invention, there is provided a mobile terminal that implements Mobile IP procedure that includes: a L2 processing section for performing an OSI Layer 2 process; a L3 processing section for performing an OSI Layer 3 process; a L2 address memory section for storing OSI Layer 2 addresses of a currently reachable router; a frame source detection section for detecting whether the OSI Layer 2 frame received via the L2 processing section is transmitted from a router of an address other than the OSI Layer 2 addresses stored in the L2 address memory section or not; and a trigger generation section for indicating the L3 processing section to initiate the handover preprocessing in the OSI Layer 3 in response to the notification from this frame source detection section. If the frame source detection section determines that the received frame comes from a router of an address other than the OSI Layer 2 addresses stored in the L2 address memory section, notification is made to the trigger generation section so that the L3 processing section can perform a handover preprocessing in response to the indication made by the trigger generation section.

By virtue of the features as described, the L3 processing section implements a handover preprocessing prior to the establishment of the OSI Layer 2 connection with the new router, thus enabling to implement the Layer 3 handover immediately after the establishment of the OSI layer 2 connection.

In addition, in accordance with a mobile device of the present invention, handover reprocessing represents a formation of a Layer 3 address based on a new OSI Layer 3 packet received by the L3 processing section from the L2 processing section and a creation of a Binding Update message addressed to a home agent of the mobile terminal.

By virtue of the features as described, it is made possible to send a Binding Update message to the home agent immediately after the establishment of OSI Layer 2.

In addition, in accordance with a mobile device of the present invention, the mobile device further includes a packet contents confirmation section for determining whether the OSI Layer 3 packet included in the received frame is a Router Advertisement message or not, characterized in that the frame source detection section notifies to the packet contents confirmation section when determining that the received frame comes from a router of an address other than the OSI Layer 2 addresses stored in the L2 address memory section, and that the packet contents confirmation section, when determining that the OSI Layer 3 packet included in the received frame is the Router Advertisement message, notifies to the trigger generation section.

By virtue of the features as described, a movement detection trigger is to be issued only when a Router Advertisement message is received from a router in which new connectivility is confirmed. That means, in a sequential IP handover processing, the process of newly obtaining a Router Advertisement message can be omitted, thus enabling to reduce the time of handover.

In addition, in accordance with the present invention, there is provided a mobile device, wherein the radio communication is performed at the same frequency both by a prior-to-movement router and by a movement destination router.

By virtue of the features as described, even in a usage state where radio communication is performed between the mobile terminal and the router, the time of handover can be reduced according to the present invention as far as communication with the mobile terminal is made at the same frequency both by a prior-to-movement router and a movement destination router.

### BRIEF DESCRIPTION OF THE DRAWINGS

FIG. 1 is a diagram illustrating a configuration of a mobile communication system according to the first exemplary embodiment of the present invention.

FIG. 2 is a diagram illustrating a configuration of a mobile terminal according to the first exemplary embodiment of the present invention.

FIG. 3 is a diagram illustrating a configuration of a mobile terminal according to the second exemplary embodiment of the present invention.

FIG. 4 is a flow chart showing the operation of the mobile terminal according to the first exemplary embodiment of the present invention.

FIG. 5 is a flow chart showing the operation of the mobile terminal according to the second exemplary embodiment of the present invention.

FIG. 6 is a diagram illustrating a L2 address list according to the first exemplary embodiment of the present invention.

FIG. 7 is a diagram showing a format of a Router Advertisement message according to the first exemplary embodiment of the present invention.

FIG. 8 is a sequence diagram showing a handover processing performed by the mobile terminal according to the first exemplary embodiment of the present invention.

FIG. 9 is a sequence diagram showing a handover processing performed by the mobile terminal according to the first exemplary embodiment of the present invention.

FIG. 10 is a sequence diagram showing a handover processing performed by the conventional mobile terminal.

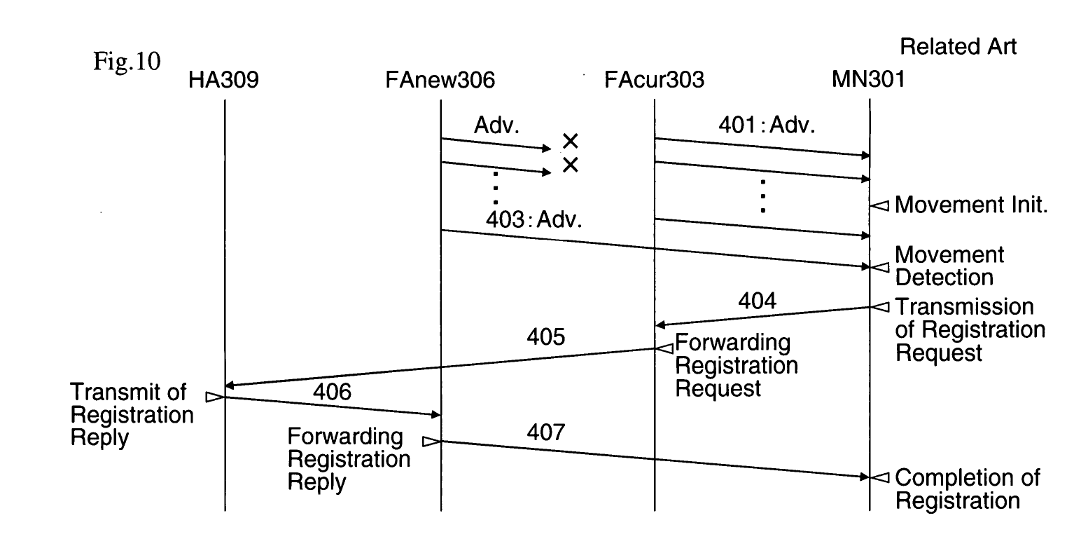

FIG. 11 is a sequence diagram showing a handover processing performed by the conventional mobile terminal.

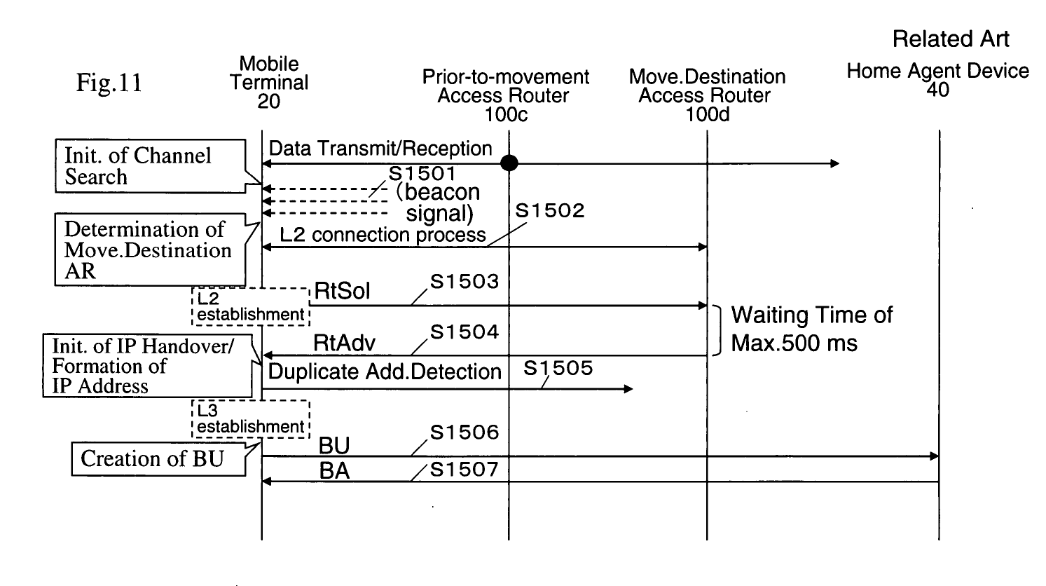

FIG. 12 is a sequence diagram showing a handover processing performed by the conventional mobile terminal.

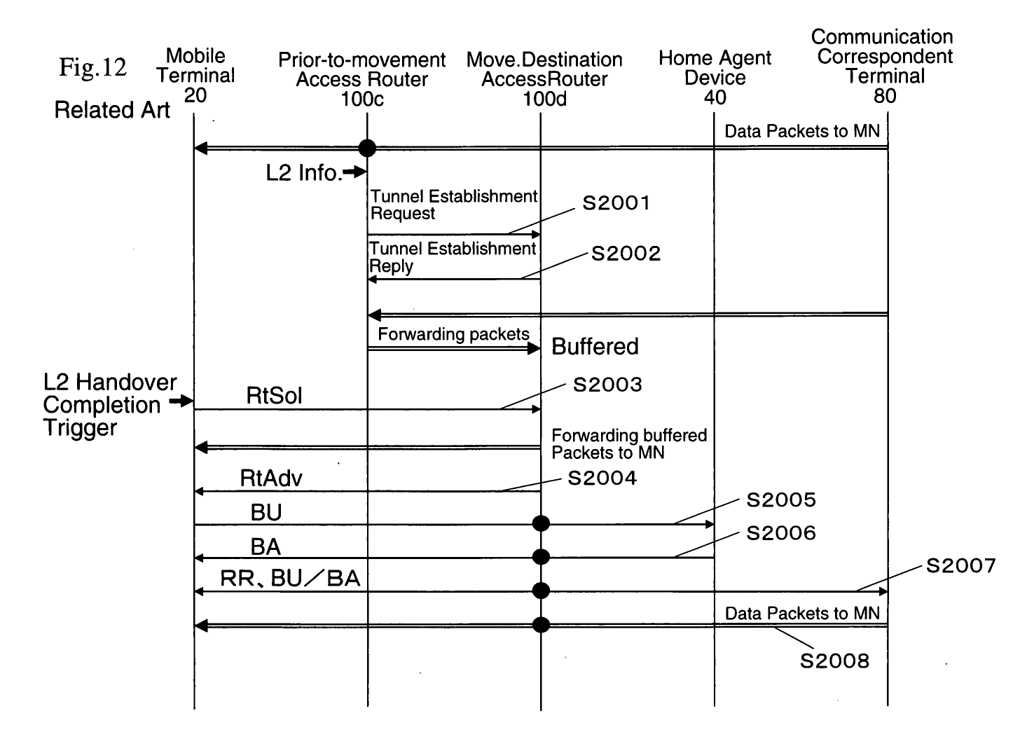

FIG. 13 is a sequence diagram showing a handover processing performed by the conventional mobile terminal.

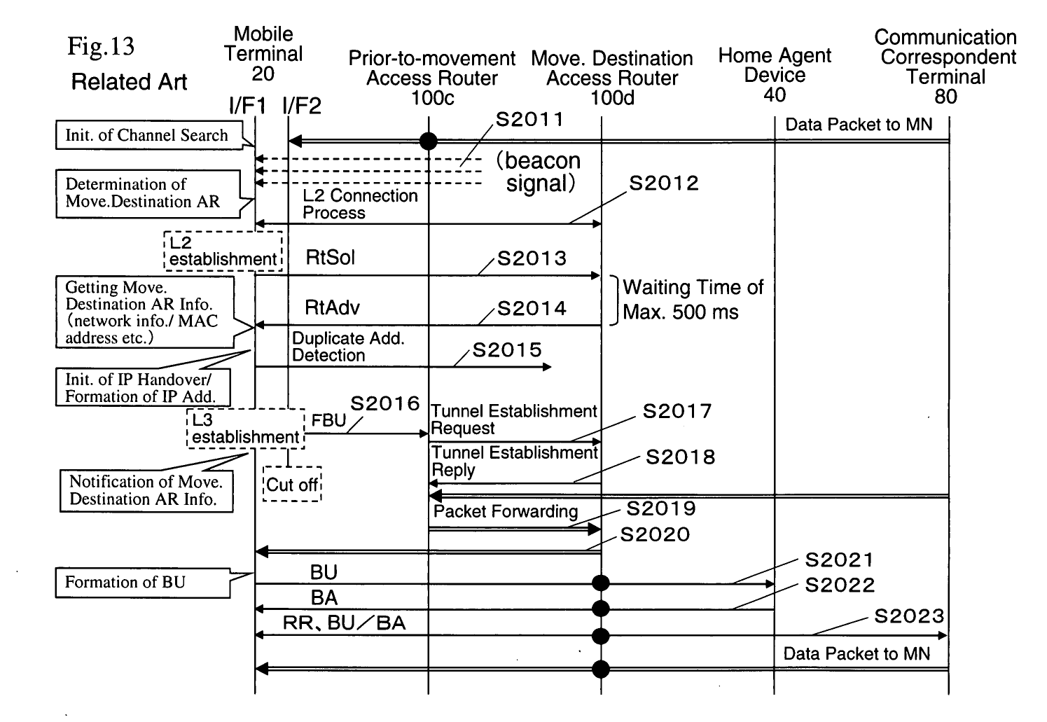

### DESCRIPTION OF THE PREFERRED EMBODIMENTS

Exemplary embodiments of the present invention are demonstrated hereinafter with reference to the accompanying drawings.

1st Exemplary Embodiment

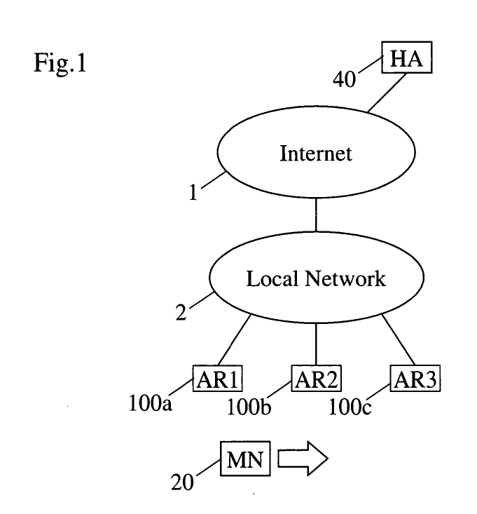

The first exemplary embodiment of the present invention is demonstrated hereinafter with reference to FIGS. 1, 2, 4 and 6.

The first exemplary embodiment of the present invention is, in the case where neighbor access routers provide radio access service at the same frequency, that a mobile terminal 20, when moving, generates a movement detection trigger in reaction to receiving a L2 frame from an access router that is different from the currently connected access router to initiate a part of the IP handover processing.

FIG. 1 is a block diagram of a mobile communication system according to the present invention.

In FIG. 1, a local network 2 connects to the internet 2, access router devices 100a to 100c connect to the local network (AR1 to AR3), a mobile terminal (MN) 20 moves while being connected to the access router device 100, and a home agent (HA) 40 houses the mobile terminal 20.

In the mobile communication system as shown in FIG. 1, the mobile terminal 20 is connected to the access router 100a but is about to go into the command of the access router 100b by moving. Herein, in the case where both of the access routers 100a and 100b are providing service at the same frequency, when the mobile terminal 20 goes into the radio area connectable to the access router 10b, it can receive a L2 frame that is transmitted by the access router 100b to its under-command radio links.

Next, configuration of the mobile terminal 20 and its operation according to the present invention is demonstrated with the use of figures.

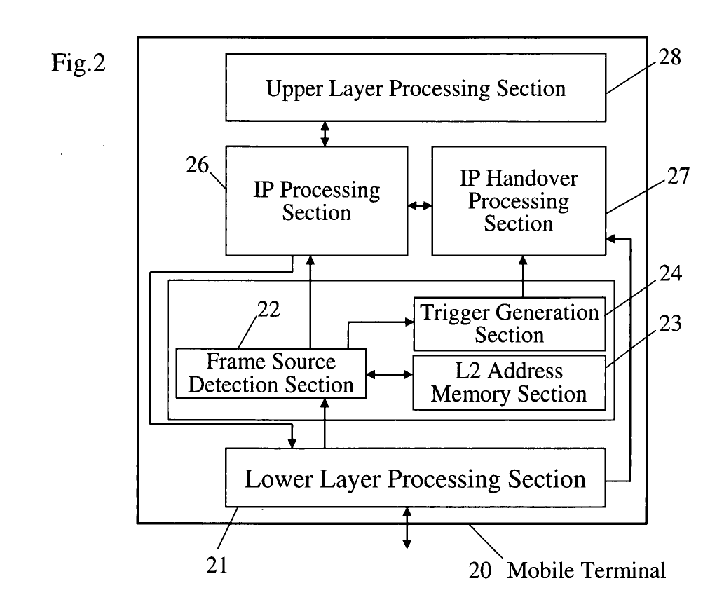

FIG. 2 is a block diagram showing the mobile terminal 20 according to the present invention.

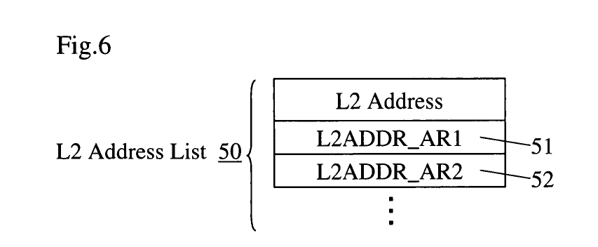

In FIG. 2, a lower layer processing section 21 is to perform processing of Layer 1 and Layer 2, a frame source detection section 22 is to detect a source address of an L2 frame forwarded from the lower layer processing section 21. An L2 address memory section 23 is to store an L2 address of a currently reachable access router, controlling it by an L2 address list 50 as shown in FIG. 6. Incidentally, the lower layer processing section 21 corresponds to the L2 processing section according to the present invention.

In addition, the L2 address memory section 23 is to delete L2 addresses that have not been used in communication for a predetermined time in sequence. Though it is not shown in the L2 address list 50, lifetime field may be established for that purpose.

Incidentally, a trigger generation section 24 is to generate a movement detection trigger for initiating a part of IP handover processing in accordance with the detection results performed by the frame source detection section 22, then forwarding the received L2 frame to an IP handover processing section 27.

An IP processing section 26 is to perform a Layer 3 processing, especially the processing of the IP layer. The IP handover processing section 27 is to perform the IP handover processing including Layer 3 Mobile IP procedure as well as Fast Mobile IP procedure. An upper layer processing section 28 is to perform processing for Layer 4 and more. Incidentally, the IP processing section 26 and IP handover processing section 27 correspond to the L3 processing section according to the present invention. Besides, though the lower layer processing section 21 is illustrated in the figure as if it were a communication interface connected to one communication system, it may also be plural communication interfaces to be connected to plural communication systems, or it may be something that mounts those interfaces in an integrative manner.

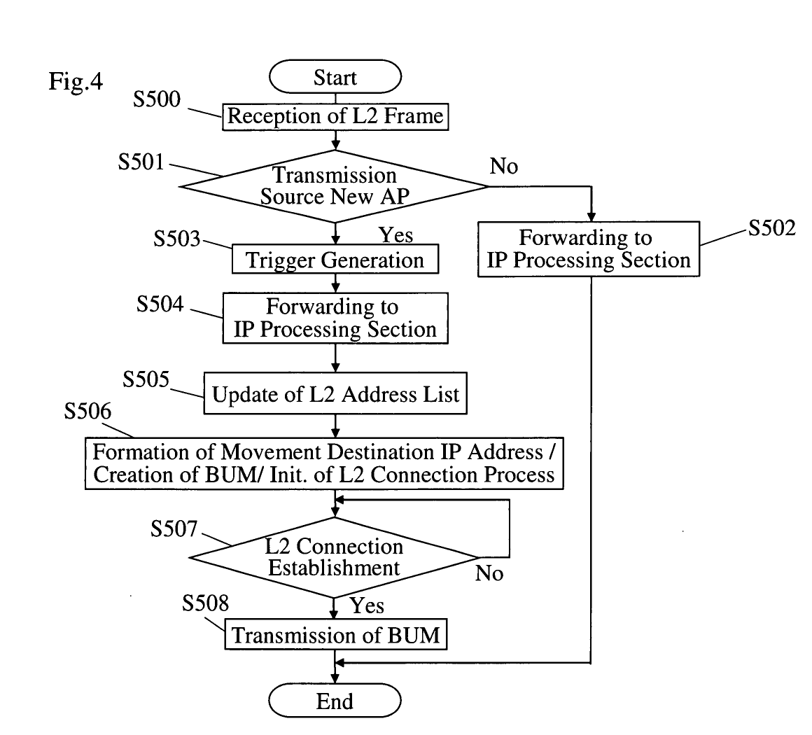

The operation of the mobile terminal 20 configured as in the above is demonstrated in detail with reference to the operation flow chart shown in FIG. 4.

First, the lower layer processing section 21, in receiving a L2 frame (S500), forwards it to the frame source detection section 22. The frame source detection section 22 extracts the transmission source address of the L2 frame to make an inquiry to the L2 address memory section 23 if the extracted address is the L2 address previously used for communication. The L2 address memory section 23 compares the L2 address about which inquiry is made by the frame source detection section 22 with the L2 addresses described on the L2 address list 50. If there exists the same address in the list, the L2 address memory section 23 replies that there is found an actual communication record; if there is no same one, it replies that there is no actual communication record (S501).

According to the reply from the L2 address memory section 23, when there is an actual communication record, the frame source detection section 22 performs a normal reception processing (S502) including forwarding IP packets extracted from the received L2 frame toward the IP processing section 26 and so on.

On the other hand, when there is no actual communication record, the frame source detection section 22 notifies the trigger generation section 24. The trigger generation section 24 issues a trigger to the IP handover processing section 27 to indicate that the movement has been detected (S503), and further forwarding the IP packets extracted from the received L2 frames toward the IP handover processing section 26 (S504). Then the frame source detection section 22 registers the L2 address in the L2 address memory section 23 (S505). The L2 address memory section 23 performs a registration processing by additionally describing a new L2 address (L2ADDR_AR2) 52 in the case where there is described an actual communication record of L2 address (L2ADDR_AR1) 51 in the L2 address list 50.

Incidentally, the order of processes S503 to S505 is not necessarily performed in the sequence as shown in FIG. 4. For example, the frame source detection section 22 may perform the notification process to the trigger generation section 24 (S503) and the registration process to the L2 address memory section 23 (S505) at the same time, being able to perform at any timings to be required.

Further, though it is described in the above that the frame source detection section 22 of the present invention may limit it processing object only to the L2 frames forwarded from the lower layer processing section 21, it is also possible that L2 frames are processed inside the lower layer processing section 21 to obtain only the necessary information for implementing the present invention. For example, it may be configured so that the transmission source L2 address of the L2 frame can be separately obtained from the lower layer processing section 21 to be able to realize a fast implementation of the above processing.

The IP handover processing section 27, in receiving a movement detection trigger and L2 frame contents, that is the received IP packets, from the trigger generation section 24, obtains a prefix value from the address field in the IP header. The prefix value is the leading 64 bits of IP address described in the Address Destination Field. As compared with the obtained prefix value and a prefix value used for generating the current-use of IP address, if there is a difference between them, IP handover is decided to be implemented for generating an IP address from the obtained prefix value. In the case of implementing a Mobile IP, the IP handover processing section 27 generates a Binding Update message (BUM) addressed to the generated IP address as the care-of address. However, actual IP handover process is not to be initiated at this stage because the connection to the access router that is recognized as a new access router by the frame source detection section 22 has not been completed yet.

On the other hand, the lower layer processing section 21 makes a connection to the corresponding access router in Layer 2 (S506) at the same time with the above, and notifies the completion to the IP handover processing section 27(S507).

In response to this, the IP handover processing section 27 performs Duplicate Address Detection test for the previously-generated IP address based on RFC2462. If there is no address collision, then the previously-generated Binding Update message is to be sent (S508).

Operation will be demonstrated hereinafter, in the mobile communication system shown in FIG. 1, as for the case where the mobile terminal of the present invention, operating like in the above, moves from the state connecting to the access router device 1 (AR1) to the area reachable to the access router device 2 (AR2) that is set at the same frequency. In that case, the mobile terminal (MN) 20 making an access at the same frequency can receive and demodulate a Layer 2 broadcast packet from both of the access router devices (AR1, AR2). That is to say, it is made possible to refer to a neighbor network information that is broadcasted in Layer 2 without performing channel search and/or terminal authorization process. However, because the terminal authorization is not completed yet, it is impossible for the mobile terminal (MN) 20 to send packets. Further, access router devices (AR1, AR2) periodically issue a Router Advertisement message, which is a message for providing information on IP networks configured on the link, toward a radio area.

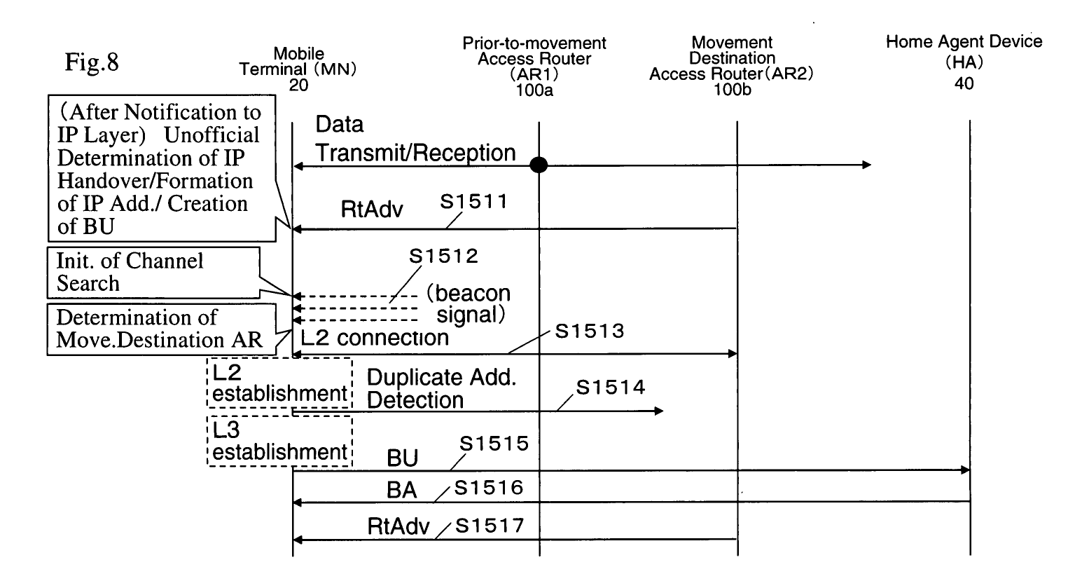

FIG. 8 is a sequence diagram illustrating a handover processing conducted by the mobile terminal in this case.

In FIG. 8, when the mobile terminal receives an IP packet (herein representing a Router Advertisement message) from the new access router (AR2) 100b (S1511) while communicating with the original access router (AR1) 100a, it performs a determination (unofficial decision) whether to implement an IP handover before the actual establishment of Layer 3 connection (establishment of L3), creation of an IP address and a Binding Update message on the basis of the IP packet simultaneously with L2 connection processing. This is because generation of IP address and so on can be made from the network prefix information included in the Router Advertisement message which the mobile terminal 20 can refer to IP layer network information (the Router Advertisement message) broadcasted in Layer 2 via both of the access routers (AR1, AR2) in the case where a neighbor access router AR2 provides a radio access at the same frequency.

Next, the mobile terminal, in deciding to switch the connection to the new access router 100b as a result of channel search (S1512), performs the L2 connection processing (S1513).

Next, after establishing the L2 connection, the mobile terminal has no more necessity for the waiting time (the maximum of 500 ms) for receiving a new Router Advertisement message and sends the created Binding Update message to the home agent device (HA) 40 (S1515) immediately after performing Duplicate Address Detection (S1514) for the IP address. By doing so, the waiting time (the maximum of 500 ms) for receiving the Router Advertisement message (S1517) after the establishment of L2 connection can be reduced to allow the handover processing to be completed in a shorter time. After that, the mobile terminal receives a Binding Acknowledgement message from the home agent device 40 (S1516) to complete the handover processing.

According to the present embodiment, as described above, the mobile terminal, in moving between the access routers each set at the same frequency, performs in advance a part of IP handover processing including the creation of IP addresses and so on at the same time with L2 connection processing in reaction to confirming the connectivility with a new access router. Then, at the moment when connection is actually established, it can initiate the remaining IP handover processing without waiting for the reception of a Router Advertisement message. Herewith, the time from the establishment of L2 connection to the reception of a Router Advertisement message and the time from the creation of an IP address to the creation of a Binding Update message can be reduced as compared with the conventional methods, enabling to complete the IP handover processing at high speed. Also therewith, time required for handover can be estimated comparatively easily.

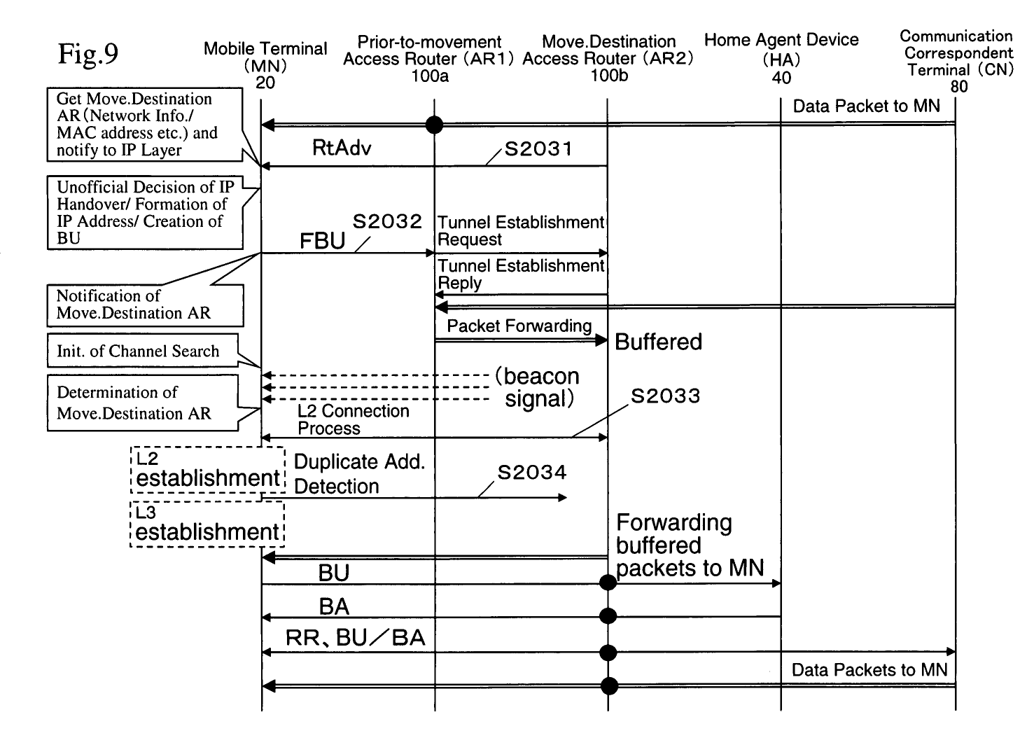

In addition, there is described the handover processing performed when the mobile terminal moves between the access router devices that perform Fast Mobile IP processing. FIG. 9 is a sequence diagram.

Because it is possible to perform Fast Mobile IP without having plural radio interfaces, and further because it can deliver a Fast Binding Update message at an early time as compared with the conventional case, it is possible to reduce packet loss that is caused by such a case as being suddenly cut off from the prior-to-movement access router.

That is, in FIG. 9, when an IP packet (herein representing a Router Advertisement message) from a movement destination access router 100b is received (S2031) in such a sate as being connected with a prior-to-movement access router 100a, it is determined (unofficial decision) to implement IP handover processing, IP address is formed and a Binding Update message is created on the basis of the IP packet. Further it is possible to notify the information of the movement destination access router 100b to the prior-to-movement access router 100a (S2032) with the use of Fast Binding Update (FBU) message. After that, the mobile terminal 20 performs channel search and then performs L2 connection processing (S2033) after the decision to switch to the movement destination access router 100b. When L2 connection is established, Duplicate Address Detection for the formed IP address is performed (S2034) to establish L3 connection. In response, packets addressed to the mobile terminal 20 that are forwarded from the prior-to-movement access router 100a to be buffered in the movement destination access router 100b are forwarded to the mobile terminal 20.

As described above, according to the movement detection method of the present invention, IP handover processing can be performed without a waiting time for receiving a Router Advertisement message after the access router connection, enabling to reduce the total time required for the handover processing.

2nd Exemplary Embodiment

The second exemplary embodiment of the present invention is demonstrated hereinafter with reference to FIGS. 1, 3, 5 and 6.

FIG. 1 shows a configuration of a mobile communication system according to the present invention, of which configuration and operation are the same as demonstrated in the first exemplary embodiment.

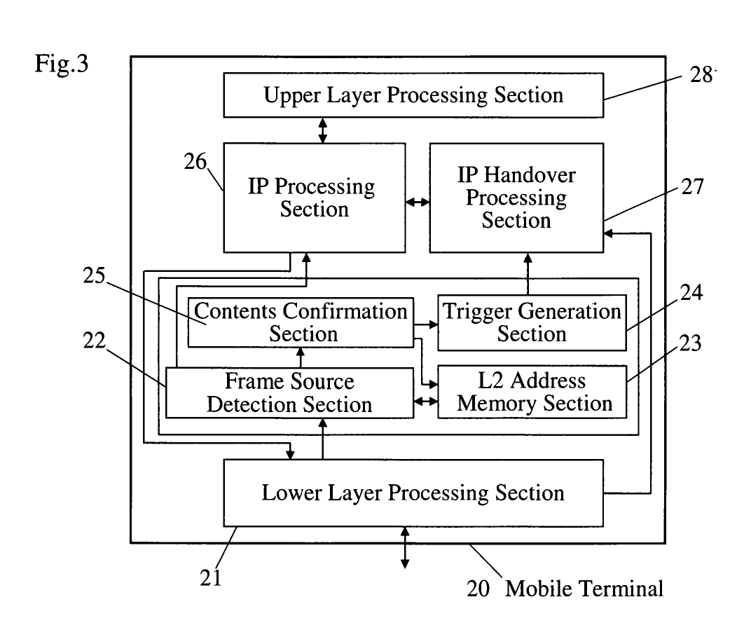

FIG. 3 is a block diagram of a mobile terminal 20 according to the present invention, which is different form the first exemplary embodiment in that there is added a contents confirmation section 25. This contents confirmation section 25 is to confirm the contents of a received L2 frame and to order to generate a trigger if the frame includes a Router Advertisement message. This contents confirmation section 25 corresponds to a packet contents confirmation section according to the present invention.

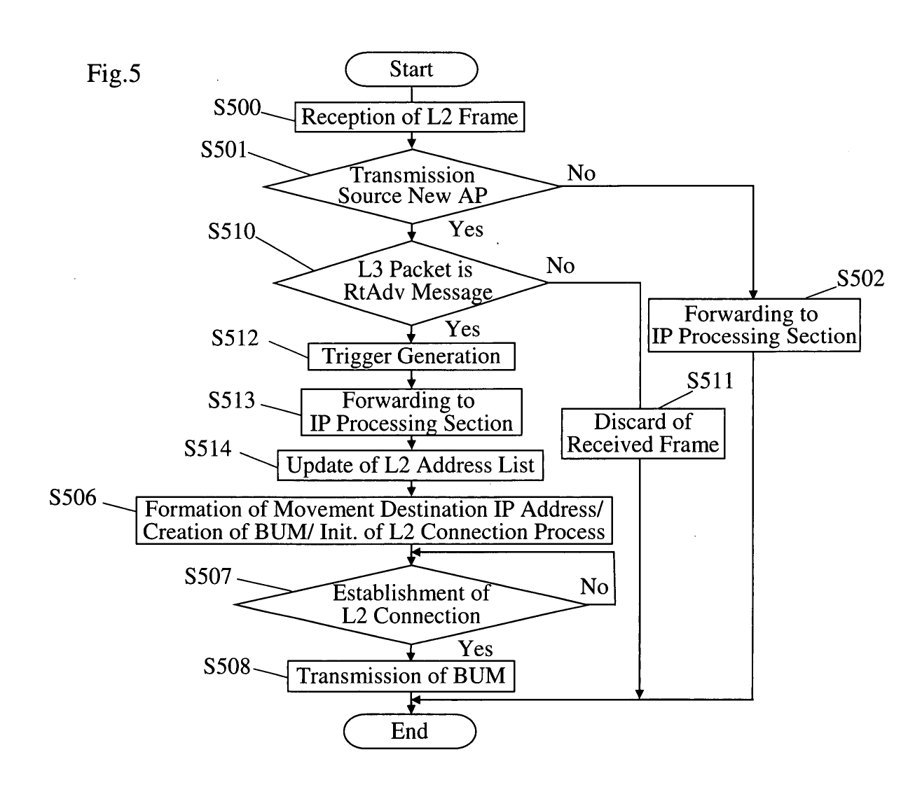

Operation of the mobile terminal 20 configured as in the above will be demonstrated in detail with the use of an operation flow chart as shown in FIG. 5.

There is no difference from the first exemplary embodiment within the procedures where a lower layer processing section 21 receives a L2 frame (S500), a frame source detection section 22 compares it with L2 addresses described on an L2 address list 50 (S501) and if it is found that the source address of L2 frame has its actual communication record, the IP packet extracted from the received L2 frame is forwarded to an IP processing section 26 (S502).

Next, if the transmission source router has no actual communication record, the frame source detection section 22 forwards the received L2 frame to the contents confirmation section 25. The contents confirmation 25 performs a confirmation processing to discriminate if the IP packet included in the L2 frame is a Router Advertisement message (S510).

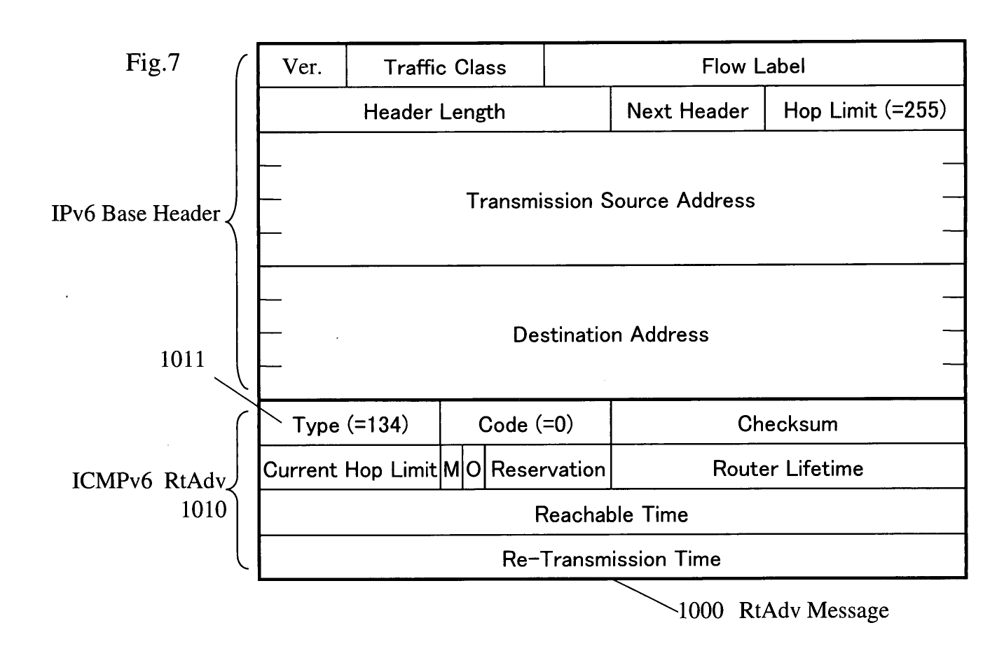

Confirmation for a Router Advertisement messages is performed by referring to an ICMP type field 1011 of the Router Advertisement message 1000 as shown in FIG. 7 for example. To be more concrete, as for the case of IPv6, it can be confirmed as a Router Advertisement message if the value of ICMP type field 1011 is “134”.

On the other hand, if the IP packet included in the L2 frame is not a Router Advertisement message 1000, the contents confirmation section 25 discards the L2 frame (S511).

When it is the Router Advertisement message 1000, the contents confirmation section 25 notifies to a trigger generation section 24. The trigger generation section 24 issues a trigger to an IP handover processing section 27 to indicate that the movement has been detected (S512), further forwarding the IP packet (Router Advertisement message) extracted from the received L2 frame to the IP handover processing section 27 (S513).

Next, the contents confirmation section 25 registers the L2 address to a L2 address memory section 23 (S514).

Incidentally, implementation order in processing S512 to S514 is not necessarily in the sequence as shown in FIG. 5. For example, it may also be configured so that the frame source detection section 22 can perform registration processing to the L2 address memory section 23 (S514) at the same time with notification processing to the trigger generation section 24 (S512), which can be performed at any required timings.

Incidentally, it is described in the above that the frame source detection section 22 and the contents confirmation means 25 limit their processing objects to the L2 frames forwarded from the lower layer processing section 21. But it is also possible that L2 frames are processed inside the lower layer processing section 21 and information necessary for implementing the present invention is exclusively extracted. For example, the frame source detection section 22 may obtain the transmission source L2 address of the L2 frame and the extracted IP packet from the lower layer processing section 21 and further forward the IP packets to the contents confirmation section 25 for performing the above-described processing.

Subsequent handover processing is the same as the steps S506 to S508 as shown in the first exemplary embodiment.

As described in the above, according to the present exemplary embodiment, handover processing is to be initiated only by the reception of a Router Advertisement message. Therefore only the prefixes delivered from the access router that controls the network can be used. As a result, it is made possible to perform the determination for IP handover and previous formation of IP addresses with a more certainty.

In addition, in creating a Binding Update message (BUM) addressed to the home agent, the received Router Advertisement message can be utilized. Therefore the waiting time for receiving a new Router Advertisement message after the establishment of Layer 2 connection can be omitted, thus enabling to reduce the time of handover processing.

As described above, the movement detection method of the present invention enables to implement IP handover processing without the waiting time for receiving a Router Advertisement message after the connection of access router, thus reducing the handover processing time in total. Further, by making it a condition that the received frame content be a Router Advertisement message, information can be limited to those given by a router managing the network that the mobile terminal connects to. As a result, information reliability to be used for IP handover processing can be improved.

1. A movement detection method in a mobile terminal that implements Mobile IP procedure, wherein the mobile terminal, comprising a list storing an OSI Layer 2 address of a currently reachable router, issues a trigger for notifying the initiation of handover processing in an OSI Layer 3 when receiving an OSI Layer 2 frame from a router of an address that is not described in the list.

2. A movement detection method comprising the steps of:
a) a mobile terminal that implements Mobile IP procedure obtaining an OSI Layer 2 address of a reachable router to store the address in a L2 address list;
b) an address determination step for determining whether, in receiving an OSI Layer 2 frame by the mobile terminal, the OSI Layer 2 address of a router sending the OSI Layer 2 frame is stored in the L2 address list or not; and
c) initiating a handover preprocessing in an OSI Layer 3 when the mobile terminal determines that the address is not stored in the address determination step.

3. The movement detection method according to claim 2, wherein the handover preprocessing comprises a formation of a new OSI Layer 3 address from the OSI Layer 2 frame newly received by the mobile terminal and a creation of a Binding Update message sent to a home agent of the mobile terminal.

4. The movement detection method according to claim 2, wherein the mobile terminal further comprises a type determining step for determining whether an OSI Layer 3 packet included in the OSI Layer 2 frame is a Router Advertisement message or not prior to the initiation of the handover preprocessing, characterized in that the preprocessing is to be initiated in the case where the packet is determined to be the Router Advertisement message in the type determining step.

5. The movement detection method according to claims 2, wherein there is performed a radio communication between the mobile terminal and the router, the radio communication being performed at the same frequency both by a router connected prior to the movement of the mobile terminal and by a router connected after the movement.

6. The movement detection method according to claims 3, wherein there is performed a radio communication between the mobile terminal and the router, the radio communication being performed at the same frequency both by a router connected prior to the movement of the mobile terminal and by a router connected after the movement.

7. The movement detection method according to claims 4, wherein there is performed a radio communication between the mobile terminal and the router, the radio communication being performed at the same frequency both by a router connected prior to the movement of the mobile terminal and by a router connected after the movement.

8. A mobile terminal that implements Mobile IP procedure, comprising:
a) an L2 processing section for performing an OSI Layer 2 processing;
b) an L3 processing section for performing an OSI Layer 3 processing;
c) an L2 address memory section for storing an OSI Layer 2 address of a currently reachable router;
d) a frame source detection section for discriminating whether an OSI Layer 2 frame received via the L2 processing section comes from a router of an address other than the OSI Layer 2 address stored in said L2 address memory section or not; and
e) a trigger generation section for indicating the L3 processing section to initiate the handover preprocessing in the OSI Layer 3 in response to the notification made by said frame source detection section,
wherein said frame source detection section is, when determining that the received frame comes from a router of an address other than the OSI Layer 2 address stored in the L2 address memory section, to notify to said trigger generation section,
said L3 processing section performing a handover preprocessing in response to the indication made by said trigger generation section.

9. The mobile terminal according to claim 8, wherein the handover preprocessing represents a formation of an OSI Layer 3 address based on a new OSI Layer 3 packet received by the L3 processing section from the L2 processing section and a creation of a Binding Update message sent to a home agent of the mobile terminal.

10. The mobile terminal according to claim 8 further comprising a packet contents confirmation section for confirming whether the OSI Layer 3 packet included in the received frame is a Router Advertisement message or not,
wherein the frame source detection section, in determining that the received frame comes from a router of an address other than the OSI Layer 2 addresses stored in the L2 address memory section, is to notify to the packet contents confirmation section,
said packet contents confirmation section notifying to said trigger generation section when confirming that the OSI Layer 3 packet included in the received frame is a Router Advertisement message.

11. The mobile terminal according to claims 8, wherein radio communication is performed at the same frequency both by a router connected prior to the movement of the mobile terminal and by a router connected after the movement thereof.

12. The mobile terminal according to claims 9, wherein radio communication is performed at the same frequency both by a router connected prior to the movement of the mobile terminal and by a router connected after the movement thereof.

13. The mobile terminal according to claims 10, wherein radio communication is performed at the same frequency both by a router connected prior to the movement of the mobile terminal and by a router connected after the movement thereof.
